(19) United States
(12) Patent Application Publication
(10) Pub. No.: US 2011/0312354 A1
(43) Pub. Date: Dec. 22, 2011

(54) WIRELESS DISASTER-PREVENTION NODE AND WIRELESS DISASTER-PREVENTION SYSTEM

(76) Inventor: Yoshio NAKAMURA, Tokyo (JP)

(21) Appl. No.: 13/197,135

(22) Filed: Aug. 3, 2011

Related U.S. Application Data
(63) Continuation of application No. PCT/JP2009/056863, filed on Apr. 2, 2009.

(51) Int. Cl. H04W 4/00; H04B 17/00

(52) U.S. Cl. 455/500; 455/226.1

(57) ABSTRACT

To determine the busy degree of the operating frequency channel caused by other systems and enable a user to know an unused frequency channel having a low communication frequency. A first usage-rate measuring unit 40 measures the usage rate of an operating frequency channel, and a second usage-rate measuring unit 42 measures the usage rates of unused frequency channels. When the usage rate measured by the first usage-rate measuring unit 40 exceeds a predetermined value to generate a busy state, a first usage-rate determining unit 44 displays the unused frequency channel having the low frequency rate, which is determined by the second usage-rate determining unit 45, to recommend the unused frequency channel as a switching destination.

### TECHNICAL FIELD

The present invention relates to a wireless disaster-prevention node and a wireless disaster-prevention system that transmit an event signal, which is wirelessly transmitted from a sensor node such as a wireless-type sensor, to a receiver to emit an alarm.

### BACKGROUND ART

Conventionally, in a wireless-type disaster-prevention system which monitors fires, a plurality of wireless-type fire sensors are installed in caution zones such as floors of a building, and, when a fire is detected by the wireless-type fire sensor, a wireless signal indicating the fire is transmitted to a wireless-reception relay installed for each floor.

The wireless-reception relay is connected to a sensor line, which is from a fire receiver. When a fire wireless signal is received, an alarming current is caused to flow to the sensor line by turning on a relay contact and a switching element, thereby transmitting a fire alarming signal to the receiver. When the receiver receives this fire alarming signal, the receiver emits a fire alarm by a means such as a sound. By virtue of such a wireless disaster-prevention system, the necessity of the sensor lines that connect the relay and the sensors which are installed for each floor of the building can be eliminated, wiring constructions can be simplified, and the installation locations of the sensors can be determined without the restrictions imposed by wiring, etc. Moreover, in the conventional wireless-type disaster-prevention monitoring system, a plurality of usable frequency channels are allocated to the system, and, upon system installation, one of the channels is selected and set as an operating frequency channel.
Patent Document 1: Japanese Patent Application Laid-Open Publication No. H5-274580
Patent Document 2: Japanese Patent Application Laid-Open Publication No. 2001-292089

However, when a plurality of devices simultaneously try to carry out the communication that uses the same frequency channel in such a conventional wireless-type disaster-prevention monitoring system, interference occurs, and the device of the signal-receiving side becomes capable of recognizing nothing but the signals output from none or one of the devices. Therefore, if another system(s) that uses the same frequency channel is in a neighboring area, the communication by this system(s) serves as a cause of the interference and a cause that lowers the certainty of the communication. Herein, the conceivable types of the other system(s) include two types, i.e., the type that uses the devices using the same telegram message format but is operated independently from the above mentioned system and the type that simply uses the same frequency channel, and both of them are the cause of interference. Upon installation of the wireless-type disaster-prevention monitoring system, it is desired to confirm that the other systems using the same frequency channel are not present in the neighboring area and select the operating frequency channel. However, generally, such an examination takes time and requires dedicated equipment. Therefore, it is difficult to carry out sufficient confirmation on site, and there is also a possibility that another system using the same frequency channel is installed in the neighboring area during operation. Moreover, if the communication frequency thereof is high, there is a problem that the certainty of the communication of the wireless-type disaster-prevention monitoring system is lowered.

### DISCLOSURE OF THE INVENTION

According to the present invention, a wireless disaster-prevention node and a wireless disaster-prevention system which determine the busyness of the frequency channels used by other systems and enable a user to know an unused frequency channel having a infrequent low communication are provided.

### (Wireless Disaster-Prevention Node)

The present invention is a wireless disaster-prevention node having:

a channel setting unit capable of setting an operating frequency channel from among a plurality of frequency channels;

a wireless communication unit receiving a wireless signal in accordance with a predetermined telegram message format output from a sensor node using a frequency channel same as the operating frequency channel set by using the channel setting unit, demodulating the wireless signal, and measuring radio-field intensity;

a first usage-field measuring unit measuring a usage rate of the operating frequency channel; and

a second usage-rate measuring unit measuring a usage rate of the unused frequency channel.

The wireless disaster-prevention node of the present invention further has a first usage-rate display unit displaying a result of the measurement of the first usage-rate measuring unit.

The wireless disaster-prevention node of the present invention may further have

a first usage-rate determining unit determining that a result of the measurement of the first usage-rate measuring unit is within a predetermined range; and

a first usage-rate display unit displaying the result of the determination of the first usage-rate determining unit.

The wireless disaster-prevention node of the present invention further has a second usage-rate display unit displaying all of or any of the usage rate of the unused frequency channel among a result of the measurement of the second usage-rate measuring unit.

The wireless disaster-prevention node of the present invention may further have

a second usage-rate determining unit obtaining the order of unused usage rates from a result of the measurement of the second usage-rate measuring unit; and

a second usage-rate display unit displaying part or all of the order of the usage rates obtained by the second usage-rate determining unit.

The second usage-rate display unit carries out the display when a result of the measurement of the first usage-rate measuring unit is within a predetermined range.

Herein, the first usage-rate measuring unit: when the wireless signal of the predetermined telegram message format is not being received, obtains the radio-field intensity A from the wireless communication unit at an every predetermined measurement interval T and increments the number N of times of measurement; when the radio-field intensity A is within a predetermined range, adds the number determined according to the radio-field intensity A to the number n of times of usage at that point; and every time the number N of times of measurement reaches a predetermined number of times, divides the number n of times of usage by the number N of times of measurement to calculate the usage rate F.

The first usage-rate measuring unit: when the wireless signal having the same telegram message format but having the transmission source ID not matching the registered ID is received, adds the number m of times of correction calculated by a predetermined method to each of the number n of times of usage and the number N of times of measurement at that point to accumulate the respective numbers; and, every time the number N of times measurement reaches a predetermined number of times, divides the number n of times of usage by the number N of times of measurement to calculate the usage rate F.

The second usage-rate measuring unit: at an every predetermined measurement interval, temporarily switches the operating frequency channel of the wireless communication unit to the unused frequency channel, obtains radio-field intensity A; when the radio-field intensity A exceeds a predetermined threshold value Ath, adds 1 to the number n of times of usage at that point; and every time the number N of times of measurement reaches a predetermined number of times, divides the number n of times of usage by the number N of times of measurement to calculate the usage rate F.

When a plurality of the unused frequency channels are present, the second usage-rate measuring unit calculates the usage rates respectively for the individual frequency channels.

Another mode of the first usage-rate measuring unit may be configured to: when the wireless signal of the same telegram message format is not being received, obtain the radio-field intensity A from the wireless communication unit at an every predetermined measurement interval T, add 1 to the number N of times of measurement, and add the value (A−Abas) obtained by subtracting a predetermined value (reference value) Abas from the radio-field intensity A to a usage quantity Q at that point to accumulate the quantity; and, every time the number N of times of measurement reaches a predetermined number of times, divide the usage quantity Q by the number N of times of measurement to calculate the usage rate F.

Another mode of the first usage-rate measuring unit may be configured to: when the wireless signal having the same telegram message format but having the transmission source ID not matching the registered ID is received, add the number m of times of correction calculated by a predetermined method to the number N of times of measurement at that point and add a value obtained by multiplying a value (A−Abas), which is obtained by subtracting a predetermined value Abas from the radio-field intensity A, by the number m of times of correction to a usage quantity Q at that point to accumulate the quantity; and, every time the number of times N of measurement reaches a predetermined number of times, divide the usage quantity Q by the number N of times of measurement to calculate the usage rate F.

The number of times of correction is calculated by dividing the communication time by the measurement interval and rounding up the number of decimals.

Another mode of the second usage-rate measuring unit may be configured to: at an every predetermined measurement interval T, temporarily switch the operating frequency channel of the wireless communication unit to the unused frequency channel, obtain radio-field intensity A, add a value (A−Abas) obtained by subtracting a predetermined value Abas from the radio-field intensity A to a usage quantity Q at that point, and, every time the number N of times of measurement reaches a predetermined number of times, divide the usage quantity Q by the number N of times of measurement to calculate the usage rate Q.

While the telegram message of the predetermined format from the sensor node is being received, the second usage-rate measuring unit prohibits the wireless communication unit from switching to the unused frequency channel. This is for preventing interference of the communication about disaster-prevention information which is the intrinsic function.

Any or all of outputs of the first usage-rate measuring unit and the second usage-rate measuring unit may be transmitted to and displayed by a receiver.

The sensor node detects a fire and transmits the wireless signal in accordance with the predetermined telegram message format; and, when the communication control unit obtains the telegram message demodulated from the wireless signal of the sensor node by the wireless communication unit and determines the fire, the communication control unit relays and transmits a fire signal to a receiver connected by a signal line and causes the receiver to emit an alarm.

(Wireless Disaster-Prevention System)

The present invention is a wireless disaster-prevention system receiving and processing, by a wireless disaster-prevention node, a wireless signal transmitted from a sensor node and transmitting a result of the processing to a receiver connected by a signal line, wherein

the wireless disaster-prevention node having:

a channel setting unit capable of setting an operating frequency channel from among a plurality of frequency channels;

a wireless communication unit receiving a wireless signal in accordance with a predetermined telegram message format output from a sensor node using a frequency channel same as the operating frequency channel set by using the channel setting unit, demodulating the wireless signal, and measuring radio-field intensity;

a communication control unit executing a process based on an telegram message when a transmission source ID obtained from the telegram message demodulated by the wireless communication unit matches a registered ID determined and registered in advance;
a first usage-rate measuring unit measuring a usage rate of the operating frequency channel; and

a second usage-rate measuring unit measuring a usage rate of the unused frequency channel.

Herein, the wireless disaster-prevention node transmits wireless monitoring information including part or all of outputs of the first usage-rate determining unit and the second usage-rate determining unit to the receiver; and,

furthermore, the receiver is provided with a monitoring information processing unit which displays occurrence of a busy state of the wireless disaster-prevention node of a transmission source and the unused frequency channel having the low usage rate to recommend the unused frequency channel as a switching destination based on the wireless monitoring information received from the wireless disaster-prevention node.

The first usage-rate measuring unit of the wireless disaster-prevention node: when the wireless signal of the same telegram message format is not being received, obtains the radio-field intensity A from the wireless communication unit at an every predetermined measurement interval T and increments the number N of times of measurement; when the radio-field intensity A is within a predetermined range, adds the value determined according to the radio-field intensity to the number n of times of usage at that point; and every time the number N of times of measurement reaches a predetermined number of times, divides the number n of times of usage by the number N of times of measurement to calculate the usage rate F.

The first usage-rate measuring unit of the wireless disaster-prevention node: when the wireless signal having the same telegram message format but having the transmission source ID not matching the registered ID is received, adds the number m of times of correction calculated by a predetermined method to each of the number n of times of us age and the number N of times of measurement at that point to accumulate the respective numbers; and, every time the number N of times measurement reaches a predetermined number of times, divides the number n of times of usage by the number N of times of measurement to calculate the usage rate F.

The second usage-rate measuring unit of the wireless disaster-prevention node: at an every predetermined measurement interval T, temporarily switches the operating frequency channel of the wireless communication unit to the unused frequency channel, obtains radio-field intensity A, and increments the number N of times of measurement; when the radio-field intensity A is within a predetermined range, adds the number determined according to the radio-field intensity A to the number n of times of usage at that point; and, every time the number N of times of measurement reaches a predetermined number of times, divides the number n of times of usage by the number N of times of measurement to calculate the usage rate F.

Another mode of the first usage-rate measuring unit of the wireless disaster-prevention node may be configured to: when the wireless signal of the telegram message format is not being received, obtain the radio-field intensity A from the wireless communication unit at an every predetermined measurement interval T, add 1 to the number N of times of measurement, and add the value (A−Abas) obtained by subtracting a predetermined value Abas from the radio-field intensity A to a usage quantity Q at that point to accumulate the quantity; and, every time the number N of times of measurement reaches a predetermined number of times, divide the usage quantity Q by the number N of times of measurement to calculate the usage rate F.

Another mode of the first usage-rate measuring unit may be configured to: when the wireless signal having the telegram message format but having the transmission source ID not matching the registered ID is received, add the number m of times of correction calculated by a predetermined method to the number N of times of measurement at that point and add a usage quantity q obtained by multiplying a value (A−Abas), which is obtained by subtracting a predetermined value Abas from the radio-field intensity A, by the number m of times of correction to a usage quantity Q at that point to accumulate the quantity; and, every time the number N of times of measurement reaches a predetermined number of times, divide the usage quantity Q by the number N of times of measurement to calculate the usage rate F.

Another mode of the second usage-rate measuring unit maybe configured to: at an every predetermined measurement interval T, temporarily switch the operating frequency channel of the wireless communication unit to the unused frequency channel, obtain radio-field intensity A, add 1 to the number N of times of measurement, add a value (A−Abas) obtained by subtracting a predetermined value Abas from the radio-field intensity A to a usage quantity Q at that point, and, every time the number N of times of measurement reaches a predetermined number of times, divide the usage quantity Q by the number N of times of measurement to calculate the usage rate F.

While the telegram message of the predetermined format from the sensor node is being received, the second usage-rate measuring unit of the wireless disaster-prevention node prohibits the wireless communication unit from switching to the unused frequency channel.

The sensor node detects a fire and transmits the wireless signal in accordance with the predetermined telegram message format; and,

when the communication control unit of the wireless disaster-prevention node obtains the telegram message demodulated from the wireless signal of the sensor node by the wireless communication unit and determines the fire, the communication control unit relays and transmits a fire signal to a receiver and causes the receiver to emit an alarm.

According to the present invention, the usage rate of other systems in an operating frequency channel and the usage rates of other systems in unused frequency channels are measured; and, when the usage rate of the other systems in the operating frequency channel is high, a busy state of the channel is displayed since the certainty of communication is lowered, and the unused frequency channel having a low usage rate is displayed and recommended, thereby acknowledging the reduction in the communication certainty during the system operation.

When a countermeasure of changing the operating frequency channel of each node of the system to the displayed and recommended unused frequency channel is taken, certainty of the communication can be ensured. When the usage rate of the other systems in the operating frequency channel is low, by displaying this fact, a user is enabled to safely operate the system. This system can be applied also to a wireless-type system that monitors the state in a certain zone like a wireless-type security system, etc. Moreover, when the number of channels for which second usage rates are measured is increased, the system can be utilized also for the use of examining the surrounding wireless environment in advance when a new wireless-type system is to be introduced.

### BRIEF DESCRIPTION OF DRAWINGS

FIG. 1 is an explanatory drawing showing an embodiment of a wireless disaster-prevention system according to the present invention;

FIG. 2 is a block diagram showing details of a wireless-reception relay and a P-type receiver of FIG. 1;

FIG. 3 is an explanatory drawing showing an telegram message format of a wireless signal received by the wireless-reception relay of FIG. 2;

FIG. 4 is a time chart showing a channel switching pattern when usage rates are measured by the wireless-reception relay of FIG. 2;

FIG. 5 is an explanatory drawing showing the registered contents of a data table provided in the wireless-reception relay of FIG. 2;

FIG. 6 is a flow chart showing a reception relay process including usage-rate measurement accompanied by channel switching by the wireless-reception relay of FIG. 2;

FIG. 7 is a flow chart showing details of the process of measuring the usage rate of an operating channel in step S4 of FIG. 6;

FIG. 8 is a flow chart showing details of the process measuring the usage rate of an unused channel in step S9 of FIG. 6;

FIG. 9 is a flow chart showing details of the process of generating usage-rate calculation parameters in step S16 of FIG. 6;

FIG. 10 is a flow chart showing details of another process of measuring the usage rate of the operating channel in step S4 of FIG. 6;

FIG. 11 is a flow chart showing details of another process of measuring the usage rate of the unused channel in step S9 of FIG. 6;

FIG. 12 is a flow chart showing details of another process of generating usage-rate calculation parameters in step S16 of FIG. 6;

FIG. 13 is an explanatory drawing showing another embodiment of the wireless disaster-prevention system according to the present invention; and

FIG. 14 is a block diagram showing details of a wireless-reception relay and an R-type receiver of FIG. 13.

### BEST MODE FOR CARRYING OUT THE INVENTION

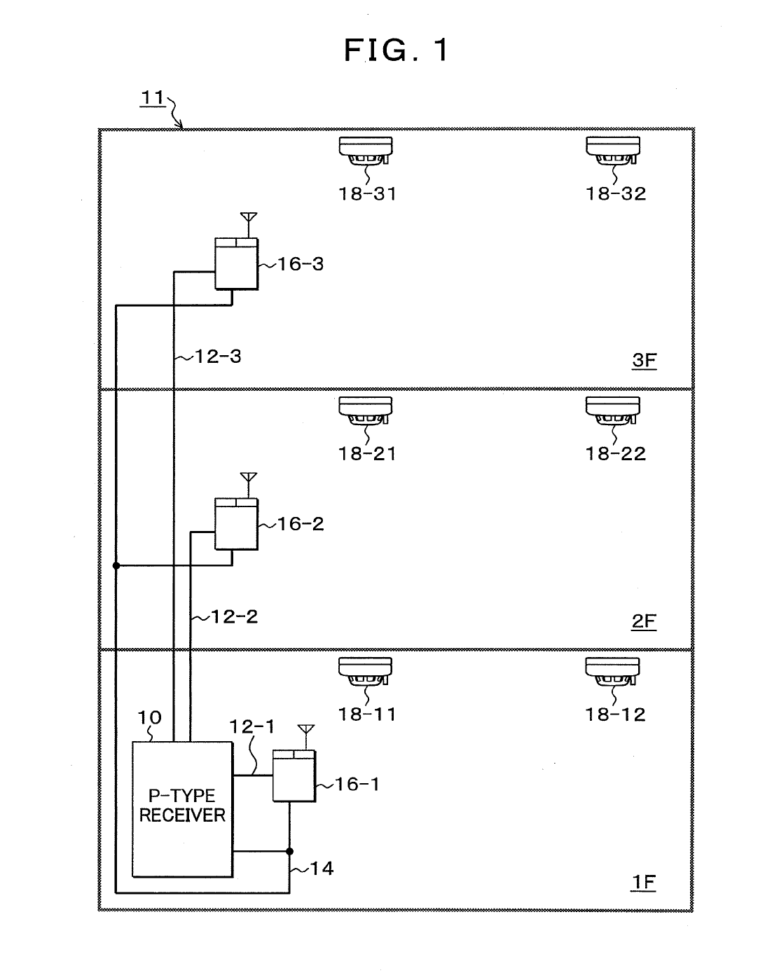

FIG. 1 is an explanatory drawing showing an embodiment of a wireless disaster-prevention system according to the present invention. In FIG. 1, a P-type receiver 10 is installed as a fire receiver on 1F of a building 11 serving as a monitoring target, sensor lines 12-1, 12-2, and 12-3 are extended to floors, respectively, from the P-type receiver 10, and a common power-supply line 14 is extended therefrom. Each of the sensor lines 12-1 to 12-3 is composed of two lines, which are not shown, and the P-type receiver 10 applies a DC voltage between the two lines. Generally, when a sensor connected to a sensor line detects a fire, the sensor reduces the resistance value between the two lines by an internal circuit, causes a current (alarming current) which is larger than the current flowing in normal time to flow through the two lines, and causes the P-type receiver 10 to detect the current, thereby transmitting a fire alarming signal. Wireless-reception relays 16-1 to 16-3 serving as wireless disaster-prevention nodes are installed on the floors of 1F to 3F, respectively, and are connected to the respective sensor lines 12-1 to 12-3 and the common power-supply line 14, which are extended from the P-type receiver 10. Moreover, wireless-type sensors 18-11, 18-12, 18-21, 18-22, 18-31, and 18-32, which function as sensor nodes, are installed on the floors. The wireless-type sensors 18-11 to 18-32, which function as sensor nodes, determine a fire when the smoke density or temperature caused by the fire exceeds a predetermined threshold value and transmit a fire event wireless signal having the fire detection as telegram message contents. A basic group of the wireless part of the present wireless system is composed of the above described wireless-reception relay and the wireless-type sensors corresponding to the wireless-reception relay. Herein, “corresponding” means that the node IDs of the wireless-type sensors 18-11 and 18-12 are registered in advance in the wireless-reception relay 16-1. When the wireless-reception relay 16-1 to 16-3 receive and demodulate the wireless signal transmitted from any of the corresponding wireless-type sensors 18-1 to 18-32 and determine fire detection, the relays cause the alarming current to flow through the sensor lines 12-1 to 12-3, thereby transmitting the fire alarming signals to the P-type receiver 10. For example, when the wireless-reception relay 16-1 receives the wireless signal transmitted from the wireless-type sensor 18-11 or 18-12, the wireless-reception relay 16-1 transmits the fire alarming signal to the P-type receiver 10. In order to monitor that normal operation is carried out, in other words, that take-away or battery run-out has not occurred, the wireless-type sensors 18-11 to 18-32 periodically transmit periodic report event wireless signals, for example, every five hours. With respect to the transmission of the periodic report event wireless signals from the wireless-type sensors 18-11 to 18-32, the corresponding wireless-reception relays 16-1 to 16-3 measure the time elapsed from the last reception of the wireless signals from the corresponding wireless-type sensors, wherein the time is measured for each of the wireless-type sensors by using a timer. When the time of the timer exceeds a certain period of time, for example, 12 hours, the relay determines that it is a periodic report abnormality in which the wireless-type sensor is not normally operating and notifies the P-type receiver 10 of the failure occurrence. In this failure occurrence notification, for example, the terminating resistance connected to each of the sensor lines 12-1 to 12-3 from the P-type receiver 10 is separated to virtually create a disconnected state, thereby giving the notification of the failure occurrence cause by the periodic report abnormality. The wireless-reception relays 16-1 to 16-3 and the wireless-type sensors 18-11 to 18-32 carry out wireless communication in accordance with, for example, the standards of specified low power wireless stations of the 400 MHz band in the case of Japan. For example, four channels are allocated as usable frequency channels, and, upon activation of the system, a particular frequency channel is selected from among them and subjected to use. Herein, between the groups installed at mutually adjacent locations, the wireless signals thereof can reach each other in some cases. The communication carried out by the devices of a certain group by using the same frequency channel sometimes works as interference for other groups. For example, for the group composed of the wireless-reception relay 16-1 and the wireless-type sensors 18-11 and 18-12, the communication carried out by the wireless-type sensor 18-21 works as interference and lowers the certainty of the wireless communication. Therefore, it is desirable that the group including the wireless-reception relay 16-1 and the group including the wireless-reception relay 16-2 select mutually different operating frequency channels. As described above, the wireless-reception relays 16-1 to 16-3 of the present embodiment are storing the node IDs of the corresponding wireless-type sensors, receive the wireless signals from the wireless sensors, and demodulate the telegram messages, which are in accordance with a predetermined format; and, when the transmission source ID obtained from the demodulated telegram message matches the registered ID, the relay executes processes in accordance with the telegram message contents as effective telegram message reception. Herein, the processes in accordance with the telegram message contents refer to, for example, state display of the wireless-type sensor, the above described transmission of the fire alarming signal, and the notification of the failure occurrence. Furthermore, the wireless-reception relays 16-1 to 16-3 of the present embodiment measure the usage rates of the frequency channels at a predetermined measurement interval while switching the operating frequency channel and unused frequency channels. When the usage rate of the operating frequency channel is increased, the relay determines that a busy state of the channel is generated and displays and recommends the unused frequency channel that has a low usage rate as a frequency channel of a switching destination. Furthermore, as the power supply to the wireless-reception relays 16-1 to 16-3, for example, DC 24 volts are supplied thereto from the P-type receiver 10 by the dedicated power-supply line 14.

In the wireless-type sensors 18-11 to 18-32, batteries such as alkaline dry batteries and lithium dry batteries are incorporated.

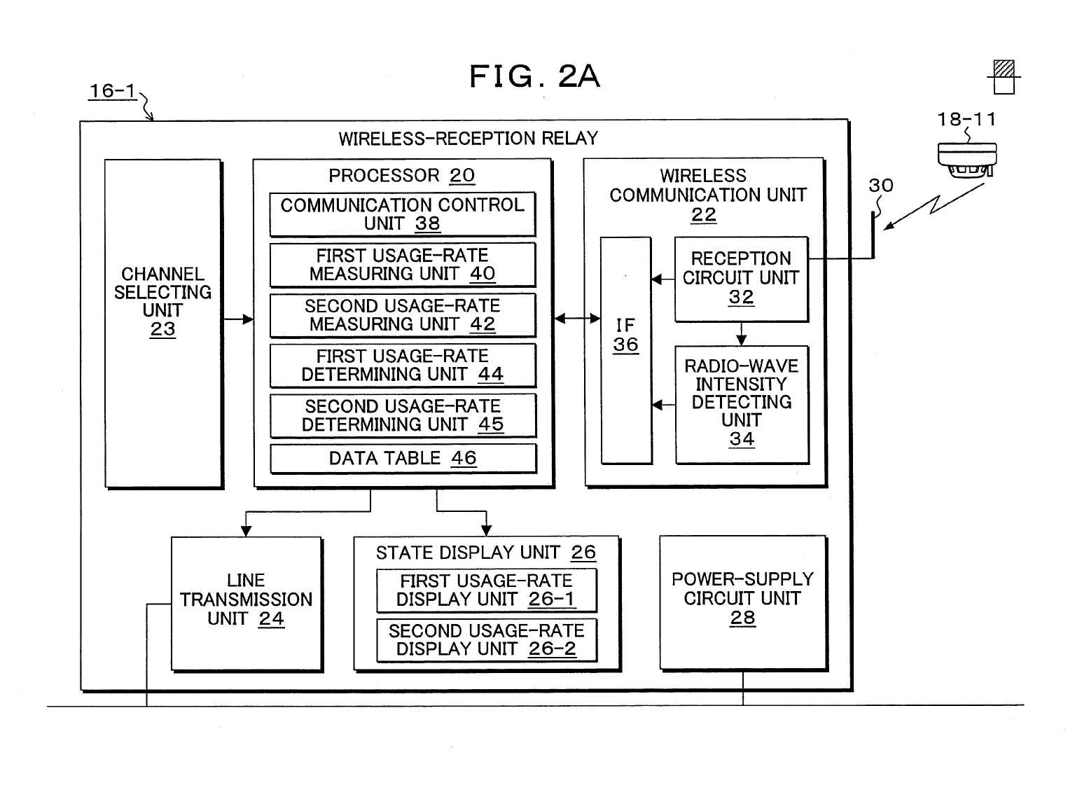

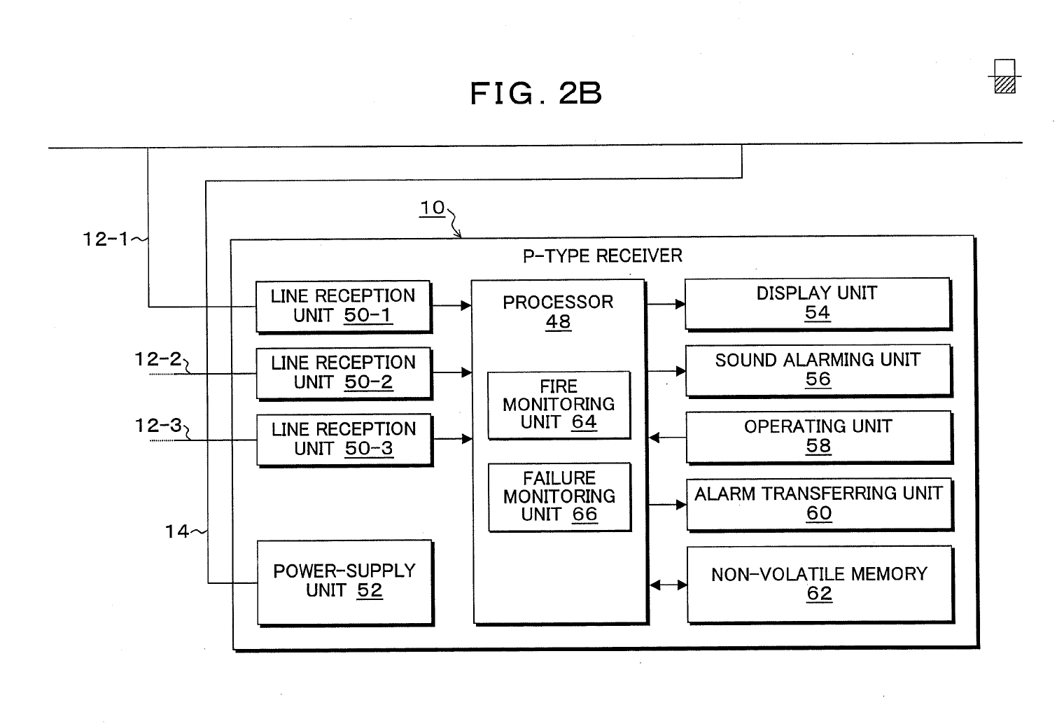

FIG. 2 is a block diagram showing details of the wireless-reception relay 16-1 and the P-type receiver 10 provided on 1F of FIG. 1. In FIG. 2, the wireless-reception relay 16-1 is composed of: a processor 20, which functions as a control unit, a wireless communication unit 22, a channel selecting unit 23, a line transmission unit 24, a state display unit 26, and a power-supply circuit unit 28. The channel selecting unit 23 connects a DIP switch for channel selection to the processor 20, the processor 20 reads the state of the DIP switch, and the processor 20 carries out channel setting with respect to the wireless communication unit 22 in accordance with the read state. The wireless communication unit 22 is provided with an antenna 30, a reception circuit unit 32, a radio-field intensity detecting unit 34, and a serial interface 36. The wireless communication unit 22 carries out wireless communication in accordance with, for example, the standards of specified low power wireless stations of the 400 MHz band in the case of Japan. The channel selecting unit 23 selects one channel from among, for example, four frequency channels ch1 to ch4 of the 400 MHz band and sets the channel as an operating frequency channel. The reception circuit unit 32 receives a wireless signal such as a fire event wireless signal or a periodic report event transmitted from the wireless-type sensor 18-11 via the antenna 30 and demodulates an telegram message from the received signal. In accordance with the receiving operation of the reception circuit unit 32, the radio-field intensity detecting unit 34 outputs a radio-field intensity detecting signal (for example, a voltage corresponding to the radio-field intensity thereof).

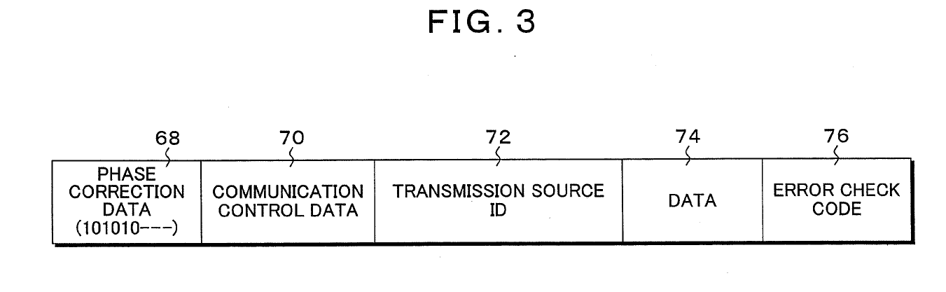

Not only upon reception of the wireless signal from the wireless sensor 18-11, but always the radio-field intensity detecting unit 34 is outputting the radio-field intensity detecting signal corresponding to the reception of the wireless signal of the same frequency channel which is selected at that point. Based on a read command from the processor 20, the serial interface 36 carries out serial data transfer of the telegram message demodulated by the reception circuit unit 32 or the radio-field intensity detected by the radio-field intensity detecting unit 34. Moreover, the serial interface 36 carries out channel switching of the channel selecting unit 23 based on a channel switch command from the processor 20. The radio-field intensity signal of the DC level output from the radio-field intensity detecting unit 34 is subjected to AD conversion by the serial interface 36 and transmitted as a digital signal. As a matter of course, when output from the radio-field intensity detecting unit 34, the radio-field intensity signal may be converted to a digital signal and output to the serial interface 36. Herein, the telegram message format of the wireless signal from the wireless-type sensor 18-11 received by the wireless communication unit 22 is as shown in FIG. 3. In FIG. 3, in the telegram message format, phase correction data 68 is disposed at a head position serving as a preamble of the wireless signal, and the phase correction data 64 is “010101 . . . ” which is, for example, data having a 24-bit length. The phase correction data 68 is used for establishing a reception preparation state when demodulated by the reception circuit unit 32 provided in the wireless communication unit 22 of FIG. 2. More specifically, the phase correction data 68 establishes, for example, bit synchronization of the demodulation process in the reception circuit unit 32 by the repetition of “101010 . . . ” and generates the reception preparation state. Subsequent to the phase correction data 68, communication control data 70, a transmission source ID 72, data 74, and an error check code 76 are disposed. The communication control data 70 is the data indicating the type of the telegram message and is representing the type of the telegram message such as an telegram message indicating the state of the sensor or an telegram message indicating the periodic report.

The transmission source ID 72 is an ID of the wireless-type sensor which is the telegram message transmission source. For example, in the case in which identification of about one million sensors is presupposed for each model when there are 100 models of wireless-type sensors, the transmission source ID is data having a length of 30 to 40 bits.

The data 74 is information such as sensor output data of, for example, the smoke density or temperature detected by the wireless-type sensor.

For example, a checksum is used as the error check code 76. Referring again to FIG. 2, the processor 20 is provided with a CPU, ROM, RAM, AD conversion port, various input/output ports, and so on; the processor is provided with a communication control unit 38, a first usage-rate measuring unit 40, a second usage-rate measuring unit 42, a first usage-rate determining unit 44, and a second usage-rate determining unit 45 as the functions realized by executing programs by the CPU; and, furthermore, a data table 46 disposed in the RAM is provided. When the transmission source ID obtained from the telegram message demodulated by the wireless communication unit 22 matches the registered ID, which is registered in advance, the communication control unit 38 executes processing based on the telegram message. For example, when fire detection is determined according to the telegram message, the line transmission unit 24 is operated to cause an alarming current serving as contact output with respect to the sensor line 12-1 to flow to the P-type receiver 10, thereby transmitting a fire alarming signal thereto. When periodic report abnormality is determined, the line transmission unit 24 is operated to create a virtual disconnected state with respect to the P-type receiver 10, thereby notifying the receiver of the failure occurrence. The first usage-rate measuring unit 40 measures the usage rate F of the frequency channel which is in use. More specifically, when the wireless signal of the telegram message format shown in FIG. 3 is not being received, the first usage-rate measuring unit 40 obtains radio-field intensity A from the wireless communication unit 22 at a predetermined measurement interval T, for example, every T=1 second; and, when the obtained radio-field intensity A exceeds a predetermined threshold value Ath, the measuring unit adds 1 to the number n of times of usage until that point so that n=n+1. Every time the number N of times of measurement reaches a predetermined number of times, for example, N=21600 (corresponding to 6 hours=3600×6), the number n of times of usage at that point is divided by the number N=21600 of times of measurement to calculate a usage rate F.

In other words, the usage rate F is calculated as

F=(n/N)×100(%) (1).

For example, if the number n of times of usage in which the radio-field intensity A is exceeding the threshold value Ath is n=10 when the number N of times of measurement reaches N=1000, the usage rate F is calculated as F=1%. The usage rate F measured in this manner is representing the degree of usage outside the system carried out by reception of the wireless signals from other systems in which the operating frequency channel is not using the telegram message format which is transmitted from the wireless-type sensor and unique to the wireless disaster-prevention system. The higher the usage rate F, the higher the probability of the interference with the wireless signals of the other systems, wherein the operating frequency channel is in a busy state, and certainty of the communication thereof is low. Furthermore, when the outside-system frequency F is calculated from the expression (1) at the point when the number N of times of measurement reaches, for example, N=1000, the number N of times of measurement and the number n of times of usage are reset to N=0 and n=0, and the same process is repeated. Moreover, the first usage-rate measuring unit 40 causes the usage rate according to the wireless signals from outside of the system to also include the case in which a wireless signal having the same telegram message format as that of FIG. 3 but having the transmission source ID which does not match the registered ID is received.

This is, for example, the case in which the telegram message transmitted by the wireless-type sensor 18-21 is received by the wireless-reception relay 16-1. More specifically, when the wireless signal having the same telegram message format as that of FIG. 3 but having the transmission source ID not matching the registered ID is received, the first usage-rate measuring unit 40 obtains the number m of times of correction by a predetermined method, for example, by dividing the communication time Tr of the wireless signal obtained from the wireless communication unit 22 by the measurement interval T and rounding up the number of decimals, and the first usage-rate measuring unit adds the number m of times of correction to each of the number n of times of usage and the number N of times of measurement of that point so as to accumulate the numbers in the below manner.

n=n+m

N=N+m

Also in this case, every time the number N of times of measurement reaches a predetermined number of times, for example, 1000 times, the number n of times of usage at that point is divided by the number N=1000 of times of measurement to calculate the usage rate F according to the above described expression (1). In the case in which the number m of times of correction is obtained by dividing the communication time Tr by the measurement interval T and rounding up the number of decimals; for example, if the measurement interval T is T=1 second, and the communication time Tr is Tr=0.2 second, this process is described as:

0.2/1.0=0, remainder 0.2.

Therefore, the remainder is rounded up to obtain m=1, and calculated m=1 is added to each of the current number N of times of measurement and the number n of times of usage. If the measurement interval T is T=1 second and the communication time Tr is Tr=1.2 second, this process is described as:

1.2/1.0=1, remainder 0.2.

Therefore, the remainder is rounded up to obtain m=2, and calculated m=2 is added to each of the current number N of times of measurement and the number n of times of usage. The usage rate F of the operating frequency channel which is the measurement result of the first usage-rate measuring unit 40 is displayed by a first usage-rate display unit 26-1 of the state display unit 26 in accordance with needs. Moreover, when the first usage-rate determining unit 44 determines that the measurement result of the first usage-rate measuring unit 40 is within a predetermined range, the first usage-rate determining unit causes the first usage-rate display unit 26-1 of the state display unit 26 to display the usage rate F of the operating frequency channel.

The second usage-rate measuring unit 42 measures the usage rates F of unused frequency channels. More specifically, the second usage-rate measuring unit 42 temporarily switches the operating frequency channel of the wireless communication unit 22 to an unused frequency channel and obtain the radio-field intensity A thereof at every predetermined measurement interval; and, when the radio-field intensity A exceeds the predetermined threshold value Ath, the second usage-rate measuring unit adds 1 to the number n of times of usage at that point to obtain n=n+1 and, every time the number N of times of measurement reaches a predetermined number of times, for example, N=1000, divides the number n of times of usage at that point by the number N of times of measurement to calculate the usage rate F according to the above described expression (1). The usage rate F of the unused frequency channel which is the measurement result of the second usage-rate measuring unit 42 is displayed by a second usage-rate display unit 26-2 of the state display unit 26 in accordance with needs. Moreover, when the second usage-rate determining unit 45 determines that the measurement result of the second usage-rate measuring unit 42 is within a predetermined range, the second usage-rate determining unit causes the usage rate F of the unused frequency channel to be displayed by the second usage-rate display unit 26-2 of the state display unit 26.

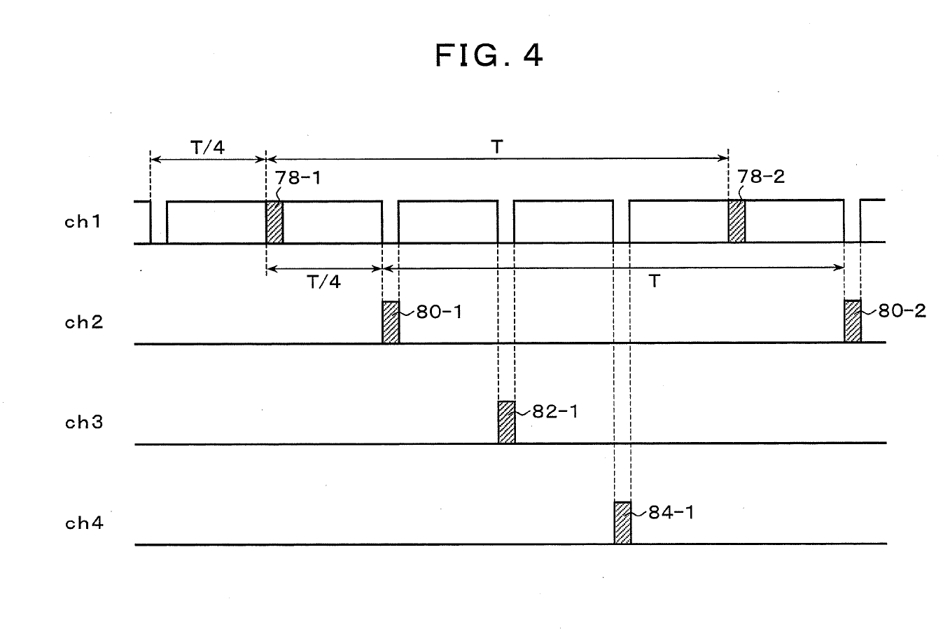

FIG. 4 is a time chart showing an example of the timing of switching the channel of the wireless communication unit 22 by the second usage-rate measuring unit 42 of FIG. 2. In FIG. 4, the reception circuit unit 32 of the wireless communication unit 22 can select and use any one of the four frequency channels ch1 to ch4 by the channel selecting unit 35, and, for example, the channel ch1 is selected as an operating frequency channel. In this case, the processor 20 issues channel switch commands respectively for the frequency channels ch1 to ch4 in the described order at every switching interval T/4 and cyclically executes temporary channel switching 78-1, 80-1, 82-1, and 84-1 over radio-field intensity measurement time ΔT. Herein, the switching target channels include the frequency channel ch1 which is currently used. By issuing the channel switch commands at such switching intervals T/4, the frequency channels ch1 to ch4 are respectively selected at the every measurement interval T, and the radio-field intensity measurement over ΔT is carried out. More specifically, each of the operating channel ch1 and the unused frequency channels ch2 to ch4 is subjected to measurement of radio-field intensity, specifically, to acquisition of the radio-field intensity by the processor 20 at the same measurement interval T. The measurement of the radio-field intensity of the frequency channel that is in use has small influence with respect to the reception of wireless signals; therefore, the intervals and the number of times of measurement of the first usage-rate measuring unit 40 and the second usage-rate measuring unit 42 may be mutually different. Referring again to FIG. 2, the usage rate of the operating frequency channel measured by the first usage-rate measuring unit 40 and the usage rates of the unused frequency channels measured by the second usage-rate measuring unit 42 are registered in the data table 46.

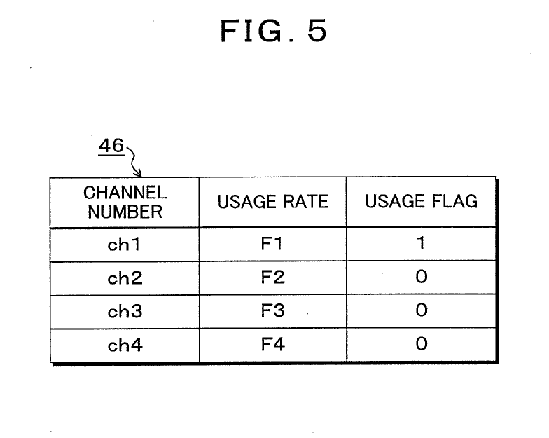

FIG. 5 shows the registered contents of the data table 46 of FIG. 2. The data table 46 has the items of the channel numbers, usage rates, and usage flags. The four frequency channels ch1 to ch4 which can be selected by the communication control unit 22 are registered as the channel numbers.

As the usage flags, the flag is set to 1 for ch1 serving as the operating frequency channel, and the flags are reset to 0 for the other unused frequency channels ch2 to ch4. The usage rate F1 measured by the first usage-rate measuring unit 42 of FIG. 2 is registered for the channel ch1 for which the usage flag is set to 1, and the usage rates F2 to F4 measured by the second usage-rate measuring unit 42 of FIG. 2 are registered for the channels ch2 to ch4 for which the usage flags are reset to 0.

Referring again to FIG. 2, when the first usage-rate determining unit 44 provided in the processor 20 determines a busy state in which the usage rate F of the operating frequency channel measured by the first usage-rate measuring unit 40 exceeds the threshold value Fth, the usage rate F of the operating frequency channel is displayed by the first usage-rate display unit 26-1 of the state display unit 26, and, furthermore, the unused frequency channel having a low usage rate measured by the second usage-rate measuring unit 42 determined by the second usage-rate determining unit 45 is displayed and recommended as a switching destination by the second usage-rate display unit 26-2 of the state display unit 26. For example, the usage rate F1 of the operating frequency channel ch1 is read from the data table 46 shown in FIG. 5 and compared with the threshold value Fth. If the usage rate is exceeding the threshold value Fth, it is determined that the current operating frequency channel is in a busy state in which certainty of communication is lowered, the usage rates F2 to F4 of the unused frequency channels ch2 to ch4 of the data table 46 are read, and the frequency channel having the lowest usage rate among them is displayed and recommended as a frequency channel of a switching destination. When the first usage-rate determining unit 44 determines the state of the operating frequency channel when the usage rate F is exceeding the threshold value Fth, the virtual disconnected state can be created by separating the terminating resistance connected to the terminal of the sensor line 12-1, which is from the P-type receiver 10, by operating the line transmission unit 24, and a failure detection signal can be transmitted to the P-type receiver 10 so as to also carry out failure display (line failure display) of the wireless-reception relay 16-1. With the failure display by the P-type receiver 10, it is unknown that what kind of failure has occurred. Therefore, the fact that the operating frequency channel is busy can be known when an operator goes to the wireless-reception relay 16-1, which is the failure source, and sees the display of the state display unit 26. The state display unit 26 is also displaying and recommending the frequency channel of the switching destination. Therefore, the current operating frequency channel in which the busy state has been generated is switched to the displayed and recommended frequency channel having the lowest usage rate by, for example, a switching operation of the channel selecting unit 23 of the wireless-reception relay 16-1; at the same time, also with respect to all of the wireless-type sensors serving as the reception targets having the transmission source IDs, which are registered in the wireless-reception relay 16-1, as node IDs, the current operating frequency channel is switched to the same frequency channel which is recommended because of the lowest usage rate; and, as a result, certainty of the communication can be enhanced. Next, the P-type receiver 10 of FIG. 2 will be explained. The P-type receiver 10 is provided with: a processor 48, line reception units 50-1 to 50-3, a power-supply unit 52, a display unit 54, a sound alarming unit 56, an operating unit 58, an alarm transferring unit 60, and a non-volatile memory 62. The sensor lines 12-1 to 12-3 are extended from the line reception units 50-1 to 50-3 as shown in FIG. 1, and the wireless-reception relay 16-1 is connected to the sensor line 12-1. The line reception unit 50-1 detects the alarming current which flows in the switching operation by the line transmission unit 24 provided in the wireless-reception relay 16-1 and outputs a fire detection signal to the processor 48. Moreover, the line reception unit detects the separation of the terminating resistance of the line transmission unit 24 of the wireless-reception relay 16-1 or cut-off of the monitoring current upon actual disconnection of the sensor line and outputs a failure detection signal to the processor 44. The processor 48 is provided with a CPU, ROM, RAM, AD conversion port, and various input/output ports, and the functions of a fire monitoring unit 64 and a failure monitoring unit 66 are realized by executing programs by the CPU. When the reception output of the fire alarming signal is obtained by the detection of the alarming current caused by any of the line reception units 50-1 to 50-3, the fire monitoring unit 64 determines that it is a fire alarm of the corresponding sensor line, representatively displays fire by the display unit 54, and displays the zone thereof in the line unit.

Moreover, a sound fire alarm is output by the sound alarming unit 56. The failure monitoring unit 66 representatively display failure by the display unit 54 when disconnection of the sensor lines 12-1 to 12-3 is detected by the line reception units 50-1 to 50-3, displays the zone, in which the failure has occurred, by the line unit, and outputs a failure alarm from the sound alarming unit 56. The failure display and the failure alarm by the failure monitoring unit 66 may include the busy state determination result of the operating frequency channel according to the increase in the usage rate F determined by the first usage-rate determining unit 44 of the wireless-reception relay 16-1. Therefore, when the failure alarm is output by the P-type receiver 10, at least one of the failure states such as: disconnection of the sensor line, detection of the periodic report failure, and reduction in the communication certainty of the operating channel is occurring; therefore, the operator goes to the installation location of the wireless-reception relay 16-1 and checks the failure contents. At this point, if it is the busy communication failure due to increase in the usage rate F of the operating frequency channel, occurrence of crowding in the operating frequency channel can be found out by seeing the state display unit 26, and an appropriate countermeasure of switching the operating frequency channel to the frequency channel of the displayed and recommended switching destination can be taken.

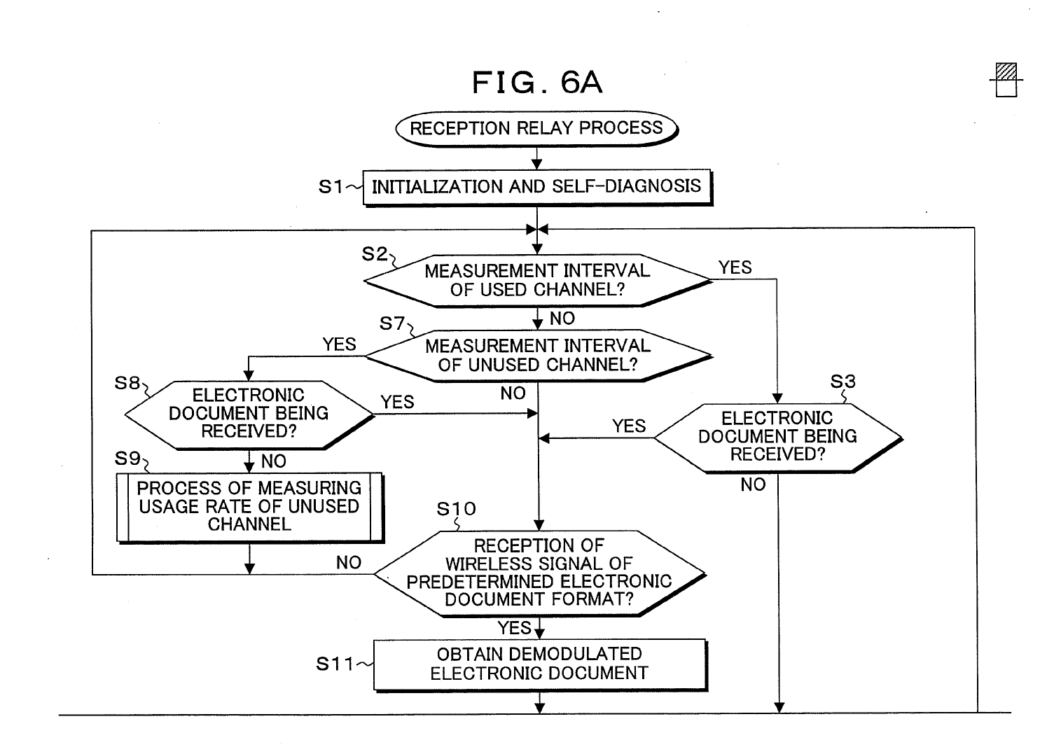

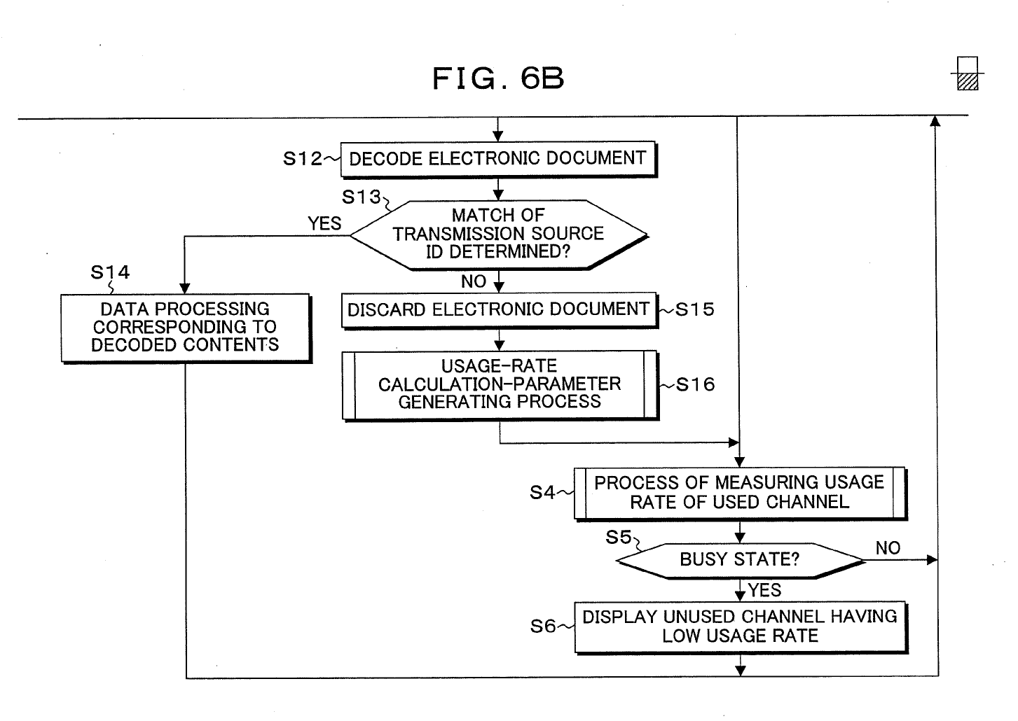

FIG. 6 is a flow chart showing a reception relay process including a process of measuring usage rates accompanied by channel switching in the wireless-reception relay of FIG. 2, and this is a process of the processor 20 provided in the wireless-reception relay 16-1 of FIG. 2. In FIG. 6, when the processor 20 is operated as a result of power-on of the wireless-reception relay 16-1, an initialization process and self diagnosis is executed in step S1; and, if there is no error, the process proceeds to step S2. In this process, the usage rates of all the channels are reset to “0”. Herein, the data table 46 of the processor 20 has, for example, the registered contents shown in FIG. 5; wherein, among the frequency channels ch1 to ch4 switchable in the wireless communication unit 22, for example, the frequency channel ch1 is the operating frequency channel as shown by the state in which the usage flag is set to 1, and the remaining frequency channels ch2 to ch4 are serving as unused channels. In step S2, reach to the measurement interval of the operating channel ch1 is checked; and, when the reach to the measurement interval is determined, the process proceeds to step S3, and whether a telegram message having the telegram message format shown in FIG. 3 used by the wireless disaster-prevention system of the present embodiment is being received or not is checked. If the telegram message is not being received, the process proceeds to step S4, and a process of measuring the usage rate F1 of the operating channel ch1 is executed. Subsequently, in step S5, whether the measured usage rate F1 is equal to or higher than the predetermined threshold value Fth or not is determined. If the rate is equal to or higher than the threshold value Fth, the process proceeds to step S6, wherein the busy state of the operating channel ch1 is determined, and the unused channel having the lowest usage rate among the usage rates F2 to F4 measured for the unused frequency channels ch1 to ch4 registered in the data table 46 of FIG. 5 at this point is displayed and recommended by the state display unit 26 as a frequency channel of a switching destination.

On the other hand, when it is not the measurement interval of the operating channel ch1 in step S2, the process proceeds to step S7, and whether it has reached any of the measurement intervals of the unused frequency channels ch2 to ch4 is checked.

When the reach to the measurement interval of an unused frequency channel, for example, the unused frequency channel ch2 is determined, the process proceeds to step S8; and, on the condition that a telegram message according to the telegram message format used by the wireless disaster-prevention system shown in FIG. 3 is not being received, the process proceeds to step S9, and a process of measuring the usage rate of the unused channel ch2 is executed. The measurement result of this usage rate measuring process is registered in the data table 46 of FIG. 5. When it is not the measurement interval of any of the operating frequency channel and the unused frequency channels in steps S2 and S7, the process proceeds to step S10, and whether the wireless signal of the predetermined telegram message format shown in FIG. 3 is being received or not is checked. When reception of this wireless signal is determined, a demodulated telegram message is obtained from the wireless communication unit 22 in step S11. Then, the telegram message is decoded in step S12, and whether the transmission source ID 72 included in the telegram message as shown in FIG. 3 matches the registered ID registered as a processing target is determined. When the transmission source ID matches the registered ID, the process proceeds to step S14, and data processing corresponding to the decoded contents of the telegram message is executed. For example, if the contents of the telegram message are fire detection, the line transmission unit 24 is operated to cause an alarming current serving as a contact output with respect to the sensor line 12-1 to flow to the P-type receiver 10, thereby transmitting a fire alarming signal thereto. On the other hand, when the transmission source ID does not match the registered ID in step S13, it is the reception of a wireless signal that is from another system having the same telegram message system. Therefore, the process proceeds to step S15, and the telegram message is discarded. Then, in step S16, a process of generating usage-rate calculation parameters taken into the usage rate measurement of the operating channel of step S4 is executed. Then, the process of step S4 of measuring the usage rate of the operating channel is executed.

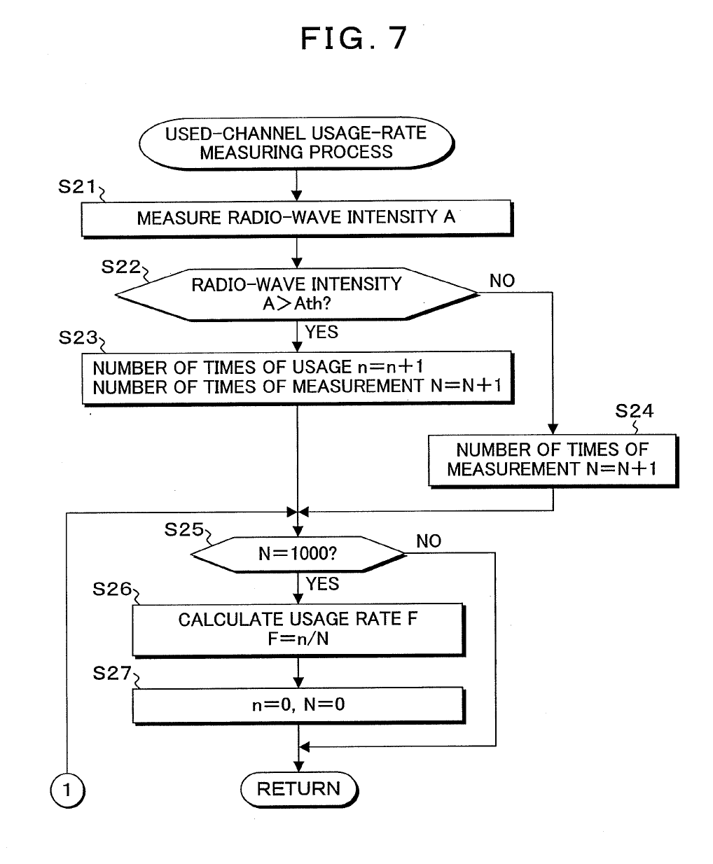

FIG. 7 is a flow chart showing details of the process of measuring the usage rate of the operating frequency channel in step S4 of FIG. 2. The process of FIG. 7 of measuring the usage rate of the operating frequency channel is executed as a process of the first usage-rate measuring unit 40 provided in the processor 20 of FIG. 2. More specifically, in the process of measuring the usage rate of the operating frequency channel, radio-field intensity A is measured in step S21. Specifically, the radio-field intensity A detected by the wireless communication unit 22 at that point is obtained by the processor 20. Subsequently, in step S22, the radio-field intensity A is compared with the predetermined threshold value Ath; and, if the radio-field intensity is exceeding the threshold value Ath, the process proceeds to step S23, the number n of times of usage is increased by 1, and, at the same time, the number N of times of measurement is similarly increased by 1. On the other hand, when the radio-field intensity A is less than the threshold value Ath in step S22, only the number N of times of measurement is increased by 1 without changing the number n of times of usage. Subsequently, whether the number N of times of measurement has reached the predetermined number of times determined in advance, for example, N=1000 is determined in step S25. When the number has reached 1000, the process proceeds to step S26, the number n of times of usage obtained at that point is divided by the number N=1000 of times of measurement, thereby calculating the usage rate F in accordance with the above described expression (1), and the calculated usage rate F is registered in the data table 46 of FIG. 5. Then, after the number n of times of usage and the number N of times of measurement at that point are reset to n=0 and N=0 in step S26, the process returns to the main routine of FIG. 6.

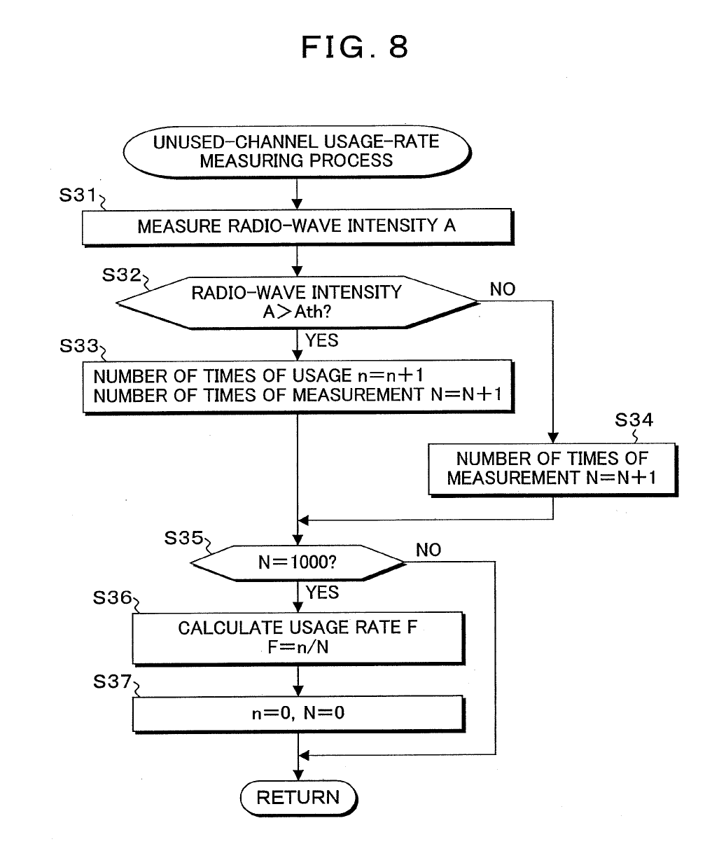

FIG. 8 is a flow chart showing details of the process of measuring the usage rate of the unused frequency channel in step S9 of FIG. 6, which is a measuring process by the second usage-rate measuring unit provided in the processor 20 of FIG. 2. In FIG. 8, in the process of measuring the usage rate of the unused frequency channel, in step S31, the radio-field intensity A is measured in the state in which the frequency channel of the wireless communication unit 22 is switched to the unused frequency channel; the radio-field intensity is compared with the predetermined threshold value Ath in step S32; and, if the radio-field intensity is exceeding the threshold value Ath, the process proceeds to step S33, wherein each of the number n of times of usage and the number N of times of measurement is increased by 1. When the radio-field intensity A is equal to or less than the threshold value Ath in step S32, the process proceeds to step S34 without changing the number n of times of usage, and the number N of times of measurement is increased by 1. Subsequently, when it is determined that the number N of times of measurement has reached the predetermined number of times, for example, 1000 times in step S35, the process proceeds to step S36, the usage rate F of the unused frequency channel is calculated by dividing the number n of times of usage by the number N=1000 of times of measurement at that point, and the calculated usage rate F is registered in the data table 46 of FIG. 5. Then, after the number n of times of usage and the number N of times of measurement are reset to n=0 and N=0 in step S37, the process returns to the main routine of FIG. 6.

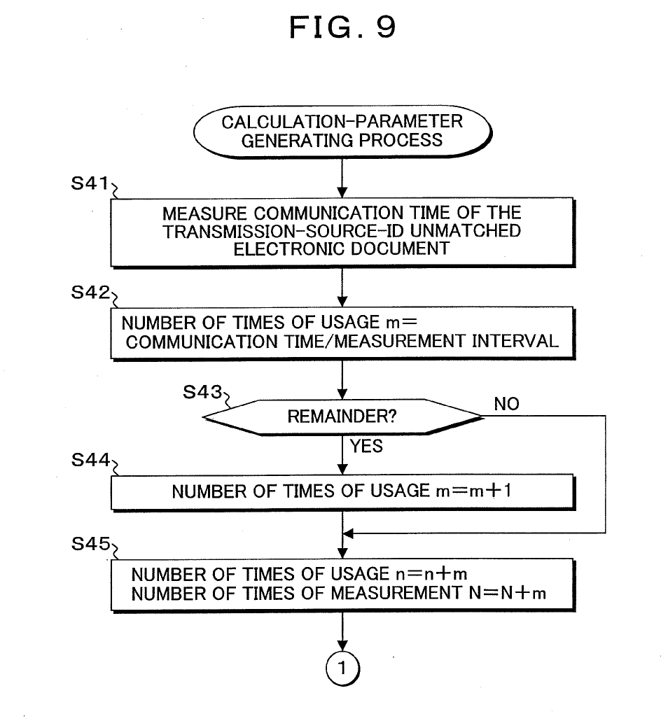

FIG. 9 is a flow chart showing details of the process of generating the usage-rate calculation parameters of step S16 of FIG. 2. The usage-rate calculation parameter generating process of FIG. 9 is a process carried out when a wireless signal from another system having the same telegram message system is received, wherein the received telegram message has the same format as the telegram message format of FIG. 3 but has a transmission source ID not matching the registered ID. Therefore, instep S41, the communication time Tr of the telegram message having the unmatched transmission source ID is measured. As the measurement of the communication time Tr, the time during which the radio-field intensity A exceeding, for example, the threshold value Ath is obtained from the wireless communication unit 22 can be measured in the processor 20 side. Subsequently, in step S42, the number m of times of usage (number of times of correction) is obtained by dividing the communication time Tr by the measurement interval T. Subsequently, in step S43, whether there is a remainder in the calculation result of the number m of times of usage or not is determined. If there is a remainder, the number m of time of usage is changed to m+1 in step S44. If there is no remainder, the number m of times of usage is not changed. Subsequently, in step S45, the number m of times of usage calculated based on the communication time Tr and the measurement interval T is added to each of the number n of times of usage and the number N of times of measurement. Subsequently, the process proceeds to step S25 in the operating frequency channel usage-rate measuring process of FIG. 7, and whether the number N of times of measurement has reached 1000 serving as the predetermined number of times is determined. If the number of times has reached 1000, the process proceeds to step S26, wherein the usage rate F is calculated and registered in the data table 46. Next, another embodiment of the method of calculating the usage rate by the first usage-rate measuring unit 40 and the second usage-rate measuring unit 42 of the present invention will be explained. As the other method of calculating the usage rate F in the present invention, the below expression is used when the measured radio-field intensity is A, a reference value of the radio-field intensity is Abas, and a predetermined number of times for calculating the usage rate is N.

$$\begin{matrix}[ Expression 1 ] & \\ F = {\sum }_{l}^{N} ( A - Abas ) / N & ( 2 )\end{matrix}$$

Herein, (A−Abas) is defined as a usage quantity Q. As the unit of the radio-field intensity, for example, the unit “dBm” expressed by a logarithm using 1 mW as a reference can be used. It can be calculated by dBm=10×log (radio-field intensity (mW)). For example, 1 mW yields 0.0 dBm, 5 mW yields 7.0 dBm, and 1 μW yields −30.0 dBm. Note that, if none of the devices within the range reached by radio fields is transmitting a wireless signal using the frequency channel, generally, the frequency component of the noise, which is present in the space or devices, corresponding to the frequency channel is output as radio-field intensity A; and, as the radio-field intensity A at this point, a value Anoise, for example, a value about −120 dBm lower than the case in which wireless communication is carried out is output. As the value of the predetermined threshold value Ath, a value higher than Anoise, for example, “Anoise+10 dB” is set. The intensity of the radio field that reaches the wireless-reception relay is varied by a width of about 10⁻¹² to 10⁻⁴ mW in accordance with conditions such as the distance between the wireless-type sensor and the wireless-reception relay. Therefore, using a numerical value expressed by the above described unit like dBm is appropriate for evaluating the radio-field intensity by a simple calculation like that shown in (2). The processing of the first usage-rate measuring unit 42 and the second usage-rate measuring unit 40 based on the expression (2) will be described below. First, when the first usage-rate measuring unit 40 is not receiving the wireless signal having the telegram message format shown in FIG. 3, the first usage-rate measuring unit 40 obtains the radio-field intensity A from the wireless communication unit 22 at the every predetermined measurement interval T and adds the value (A−Ath), which is obtained by subtracting the predetermined threshold value Ath from the radio-field intensity A, to the usage quantity Q to accumulate the value; and, every time the number N of times of measurement reaches the predetermined number of times, for example, 1000 times, the measuring unit divides the usage quantity Q by the number N=1000 of times of measurement to calculate the usage rate F. Note that, (A−Abas) has a positive or negative value; however, in the present embodiment, the positive value is used, and the negative value is discarded. This means to calculate (A−Abas) when the radio-field intensity A is exceeding the threshold value Abas. The usage rate F measured in this manner is representing the degree of usage of the operating frequency channel by the other systems having different telegram message systems. The higher the usage rate F, the higher the probability of the interference with the wireless signals of the other systems, wherein the certainty of communication is lowered. Also in the case in which the wireless signal having the same telegram message format as that of FIG. 3 but having a transmission source ID not matching the registered ID is received, the first usage-rate measuring unit 40 includes this in the usage rate of the operating frequency channel used by the wireless signals outside of the system. More specifically, when the first usage-rate measuring unit 40 receives a wireless signal having the same telegram message format as that of FIG. 3 but having a transmission source ID not matching the registered ID, the first usage-rate measuring unit obtains the radio-field intensity A and communication time Tr from the wireless communication unit 22, divides the communication time Tr by the measurement interval T, and obtains the number m of times of correction, wherein the number of decimals are rounded up. Then, the number m of times of correction is added to the number N of times of measurement at that point in the below manner:

N=N+m.

Furthermore, the value m (A−Abas) weighted by multiplying the value (A−Abas), which is obtained by subtracting the predetermined reference value Abas from the radio-field intensity A, by the number m of times of correction is added to the usage quantity Q at that point to accumulate the value and obtain: Q=Q+m(A−Abas). Every time the number N of times of measurement obtained in this manner reaches a predetermined number of times, for example, N=1000 times, the usage quantity Q is divided by the number N of times of measurement to calculate the usage rate F. As shown in, for example, the time chart of FIG. 4, the second usage-rate measuring unit 42: switches the operating frequency channel ch1 of the wireless communication unit 22 and the unused frequency channels ch2 to ch4 at the every predetermined measurement interval T at predetermined timing and order; obtains the radio-field intensity A at the very predetermined measurement interval T; adds the value (A−Abas), which is obtained by subtracting the predetermined threshold value Abas from the radio-field intensity A, to the usage quantity Q of the point to accumulate the value; and, every time the number N of times of measurement reaches the predetermined number of times, for example, N=1000 times, divides the usage quantity Q by the number N of times of measurement to calculate the usage rate F.

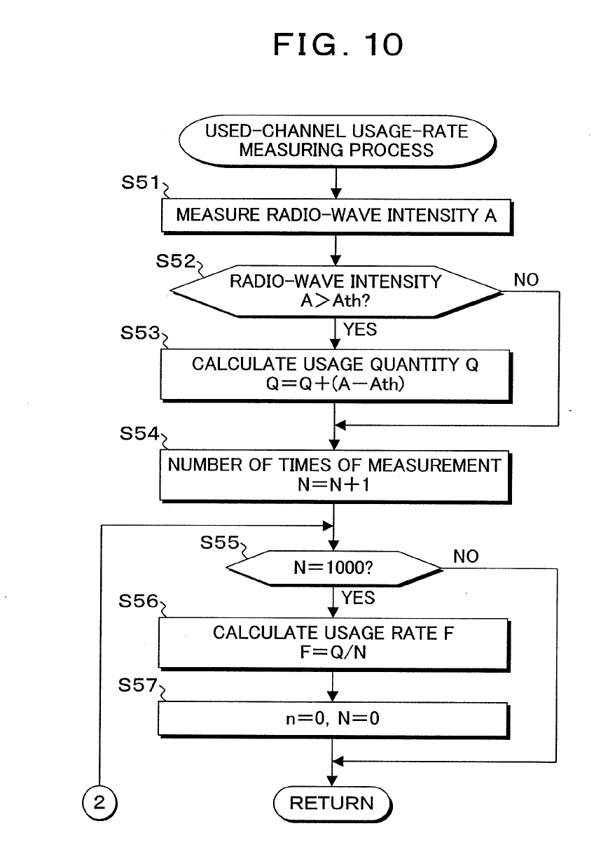

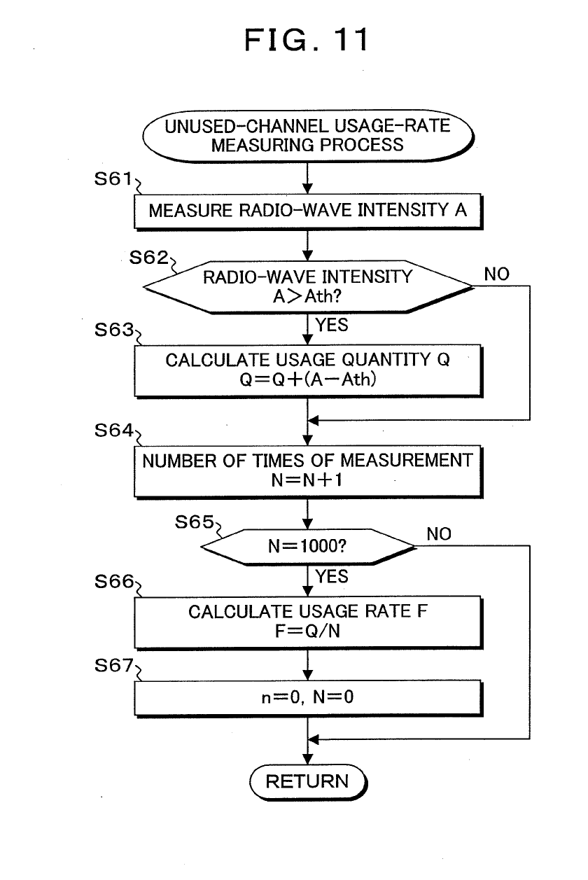

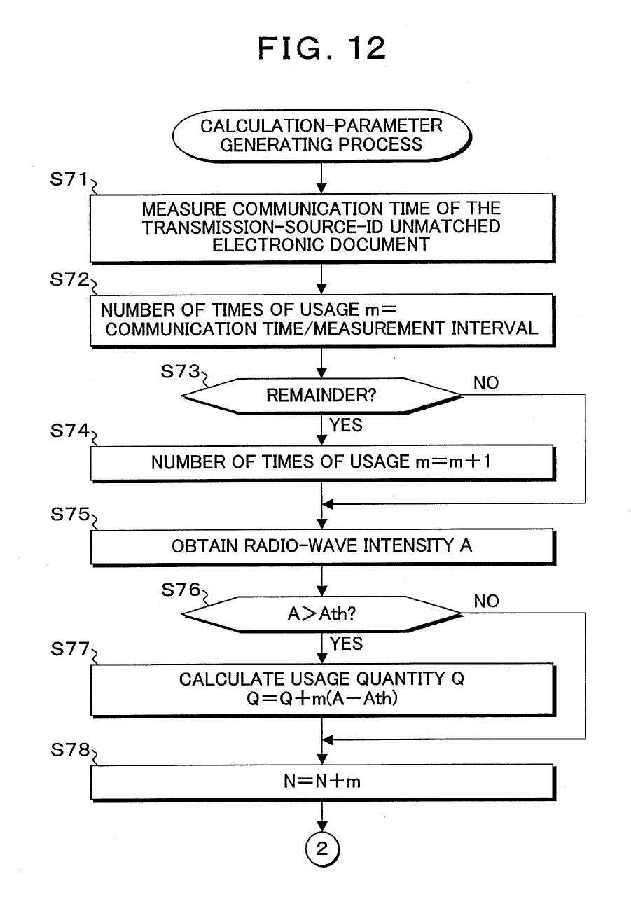

FIG. 10, FIG. 11, and FIG. 12 are flow charts showing details of the processes in steps S4, S9, and S16 of FIG. 6 in the case in which the usage-rate calculating method according to above described expression (2) is employed. FIG. 10 shows the operating channel usage-rate measuring process of step S4 of FIG. 6 employing the usage-rate calculating method of above described expression (2). First, the radio-field intensity A of the operating channel ch1 is measured in step S51; and, then, if the radio-field intensity A is equal to or higher than the predetermined threshold value Abas instep S52, the usage quantity Q is calculated as

Q=Q+(A−Abas)

in step S53.

Subsequently, the number N of times of measurement is increased by one in step S54. Then, when it is determined in step S55 that the number N of times of measurement has reached the predetermined number of times, for example, 1000 times, the process proceeds to step S56, wherein the usage rate F is calculated and registered in the data table 46. Then, after the number n of times usage and the number N of times of measurement are reset to n=0 and N=0 in step S57, the process returns to the main routine of FIG. 6.

FIG. 11 is a flow chart showing details of the unused channel usage-rate measuring process of step S9 of FIG. 6 according to the usage-rate calculating method of the above described expression (2). In the unused channel usage-rate measuring process of FIG. 11, in the state in which the channel switch command has been sent to the wireless communication unit 22 and has changed the channel to an unused channel, for example, the unused channel ch2, the radio-field intensity A is measured in step S61; and, subsequently, if the radio-field intensity A is exceeding the threshold reference value Ath in step S62, the usage quantity Q is calculated as Q=Q+(A−Abas) in step S63. Subsequently, the number N of times of measurement is increased by one in step S64; and, when it is determined in step S65 that the number N of times of measurement has reached 1000, the usage rate F of the unused channel is calculated and registered in the data table 46 in step S66. Then, after the number n of times of usage and the number N of times of measurement at that point are reset to n=0 and N=0 in step S67, the process returns to the main routine of FIG. 6.

FIG. 12 is a flow chart showing details of the usage-rate calculation parameters generating process of step S16 of FIG. 6 in the case in which the usage-rate calculating method according to the above described expression (2) is employed. In FIG. 12, after the communication time Tr of the telegram message having an unmatched transmission source ID is measured in step S71, the number m of times of usage is obtained by dividing the communication time Tr by the measurement interval T in step S72. Subsequently, if there is a remainder in the calculation result of the number m of times of usage in step S73, 1 is added to the number m of times of usage in step S74. Subsequently, the radio-field intensity A of the wireless signal at that point is obtained in step S75. Then, if the radio-field intensity A is exceeding the reference value Abas in step S76, the usage quantity Q is calculated as

Q=Q+m(A−Abas)

in step S77. Subsequently, in step S78, the number m of times of correction obtained from the communication time Tr and the measurement interval T is added to the number N of times of measurement.

Subsequently, the process proceeds to step S55 of the operating channel usage-rate measuring process of FIG. 10; and, when it is determined that the number N of times measurement has reached 1000, the process proceeds to step S56, wherein the usage rate F is calculated by dividing the usage quantity Q obtained at that point by the number N=1000 of times of measurement and is registered in the data table 46. Herein, the point to which attention should be paid in the usage-rate measurement of the unused channel in the present embodiment is that the reception of important wireless signals caused by fire detection or the like by the wireless-type sensor may be interfered when the channel is switched to the unused channel to measure the radio-field intensity; and it is important to prevent the reception of such fundamental wireless signals from being impaired by the switching to the unused channel. In order to solve such a problem, the process of FIG. 6 is configured so that the usage-rate measuring processes of the operating channel and the unused channel are not carried out while the telegram message of the wireless signal from the wireless-type sensor is being received in steps S3 and S8. As another method of preventing the wireless signal from the wireless-type sensor from not being received due to the switching of the unused frequency channel, when the telegram message having the same contents is continuously transmitted a plurality of times from the wireless-type sensor, the telegram message can be normally received when the channel is returned to the operating frequency channel even in the case in which the channel is switched to the unused frequency channel at particular timing of the telegram message. Furthermore, the time during which the reception in the operating frequency channel cannot be carried out is reduced when the radio-field intensity measurement time ΔT, during which the channel is switched to the unused frequency channel, is reduced to be shorter than the time taken for the reception of one telegram message.

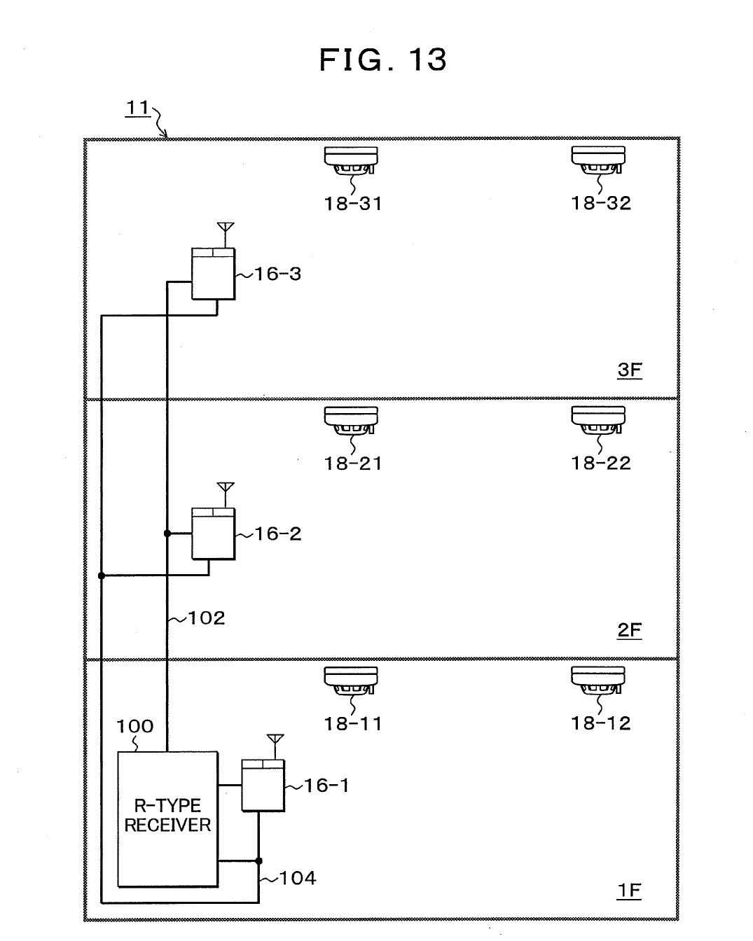

FIG. 13 is an explanatory drawing showing another embodiment of the wireless disaster-prevention system according to the present invention, and this embodiment is characterized by using an R-type receiver provided with a data transmission function. In FIG. 13, the R-type receiver 100 is installed on 1F of a building 11 serving as a monitoring target, and a transmission line 102 and a power-supply line 104 are extended with respect to 1F to 3F from the R-type receiver 100 and connect the wireless-reception relays 16-1 to 16-3 installed respectively on the floors. Moreover, the wireless-type sensors 18-11 to 18-32 which function as sensor nodes are installed on the floors. The R-type receiver 100 is capable of carrying out data transmission bi-directionally between the wireless-reception relays 16-1 to 16-3 by the transmission line 102.

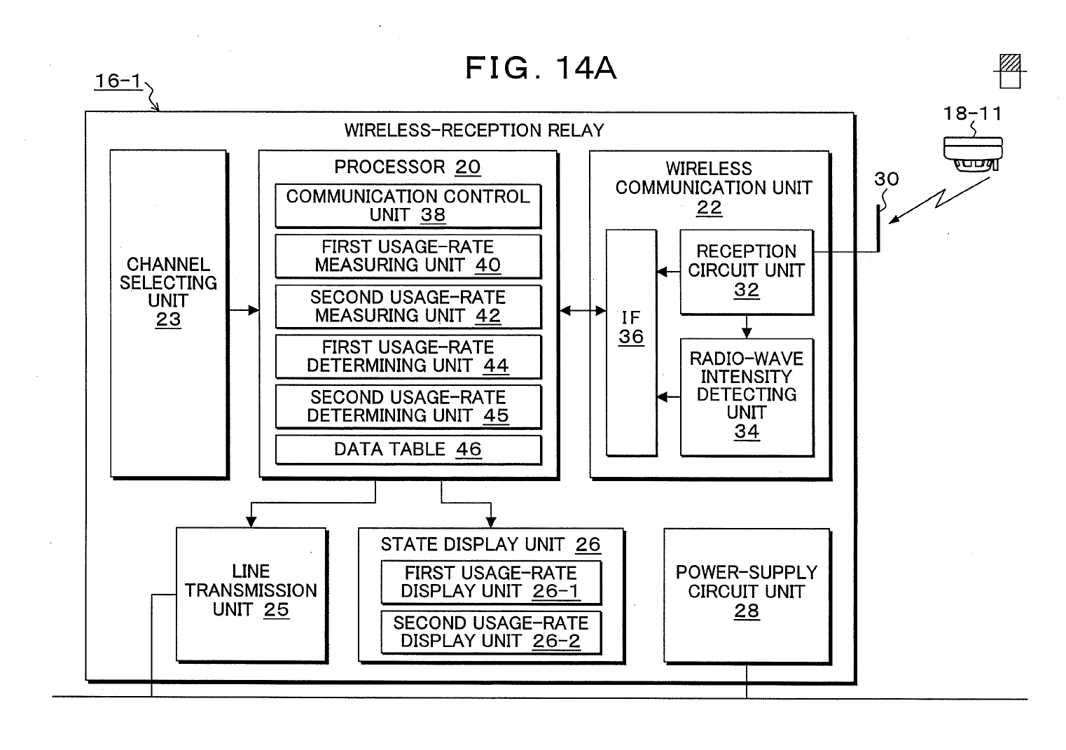

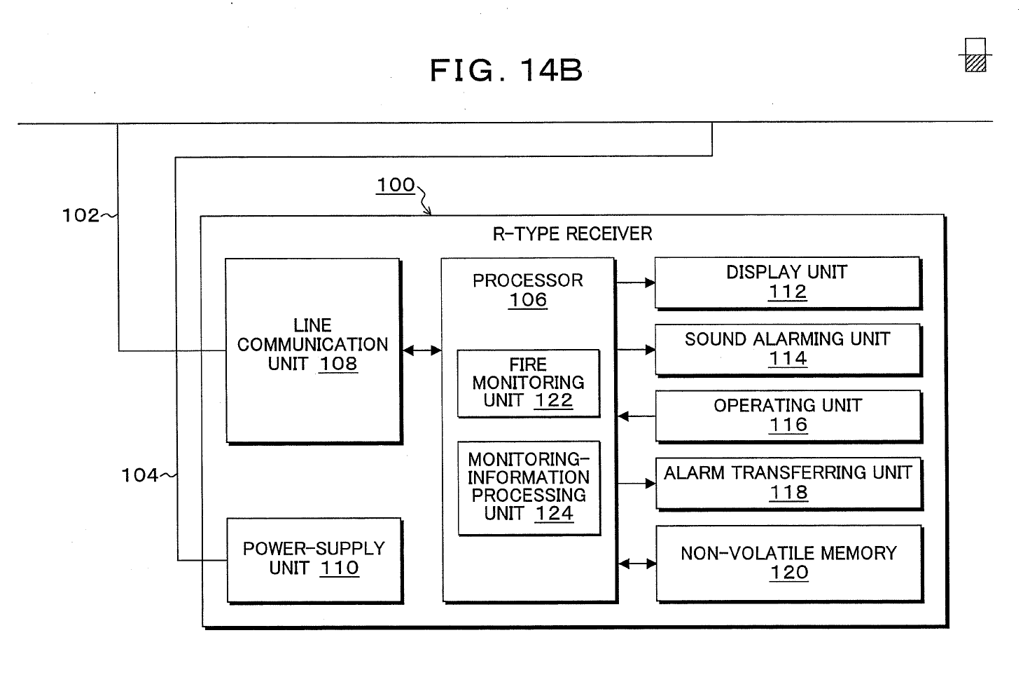

FIG. 14 is a block diagram showing details of the wireless-reception relay and the R-type receiver of FIG. 13. In FIG. 14, the wireless-reception relay 16-1 is basically same as that of the embodiment of FIG. 2, but is different in the point that the line transmission unit 24 for the P-type receiver 10 of FIG. 2 is changed to a line communication unit 25 corresponding to the R-type receiver 100 in FIG. 14. Moreover, when the first usage-rate determining unit 44 provided in the processor 20 of the wireless-reception relay 16-1 determines a crowded state due to reduction in the usage rate of the operating frequency channel, the first usage-rate determining unit transmits wireless monitoring information, which includes the busy state of the operating frequency channel and an unused frequency channel having a low usage rate, from the line communication unit 25 to the R-type receiver 100. The constitution and operations other than that are same as those of the embodiment of FIG. 2. The R-type receiver 100 is provided with: a processor 106, a line communication unit 108, a power-supply unit 110, a display unit 112, a sound alarming unit 114, an operating unit 116, an alarm transferring unit 118, and a non-volatile memory 120. The line communication unit 108 carries out data transmission bi-directionally between the wireless-reception relays 16-1 to 16-3 connected to the transmission line 102. Therefore, unique addresses are allocated to the wireless-reception relays 16-1 to 16-3 in advance for data communication.

The positions of the wireless-type sensors in the building can be specified by the combinations of the addresses allocated to the wireless-reception relays and the IDs of the wireless-type sensors.

A fire monitoring unit 122 and a radio-field monitoring information processing unit 124 are provided in the processor 106 as the functions realized by execution of programs. When the data including fire detection is received from any of the wireless-reception relays 16-1 to 16-3 by the line communication unit 108, the fire monitoring unit 122 representatively carries out fire display by the display unit 112, specifies the fire generated zone according to the transmission source ID, and displays that. Moreover, a sound fire alarm is output by the sound alarming unit 114. Based on the wireless monitoring information received from the wireless-reception relays 16-1 to 16-3, the radio-field monitoring information processing unit 124 causes the display unit 112 to display and recommend the occurrence of the busy state at the wireless-reception relay serving as a transmission source and an unused frequency channel having a low usage rate as a switching destination. Thus, the degree of channel busyness in the operating frequency channel which is caused by the wireless signals from the other systems and serves as a cause that lowers the certainty of the communication of the wireless-reception relays 16-1 to 16-3 connected to the transmission line 102 of the R-type receiver 100 is monitored; and, at the same time, when the busy state of the channel is reported, the frequency channel which can be the switching destination and has the low usage rate can be found out by the recommendation display to take an appropriate countermeasure. Upon shipment from a factory, standard values are set and stored in a storage device such as a non-volatile memory as the threshold value Ath for determining the radio-field intensity and the threshold value Fth for determining the usage rate F in the wireless-reception relay in the above described embodiments; however, when the R-type receiver 100 of FIG. 14 is connected by signal lines, the threshold values may be set for the wireless-reception relay by data transmission by the operation on the receiver. Moreover, in the embodiment of FIG. 14, the usage rate is measured in the wireless-reception relay 16-1 side to determine the busy state of the channels. However, the usage rates of the operating frequency channel and the unused frequency channels measured in the wireless-reception relay 16-1 side may be transmit ted to and accumulated in the R-type receiver 100; and the R-type receiver 100 side may determine the busy state of the channels, determine the frequency channel of the switching destination, and display and recommend the frequency channel or may display the usage rates of all of the frequency channels. In the wireless-reception relay 16-1 of FIG. 2 and FIG. 14, the processor 20 issues the radio-field intensity read command to the wireless communication unit 22 to obtain the radio-field intensity. However, the radio-field intensity detection signal from the radio-field intensity detecting unit 34 of the wireless communication unit 22 may be obtained by directly inputting the signal to the AD conversion port of the processor.

The present invention includes arbitrary modifications that do not impair the objects and advantages thereof, and the present invention is not limited by the numerical values shown in the above described embodiments.

1. A wireless disaster-prevention node comprising:
a channel setting unit capable of setting an operating frequency channel from among a plurality of frequency channels;
a wireless communication unit receiving a wireless signal in accordance with a predetermined telegram message format output from a sensor node using a frequency channel same as the operating frequency channel set by using the channel setting unit, demodulating the wireless signal, and measuring radio-field intensity;
a communication control unit executing a process based on the telegram message when a transmission source ID obtained from the telegram message demodulated by the wireless communication unit matches a registered ID determined and registered in advance;
a first usage-rate measuring unit measuring a usage rate of the operating frequency channel; and
a second usage-rate measuring unit measuring a usage rate of the unused frequency channel.

2. The wireless disaster-prevention node according to claim 1, further comprising a first usage-rate display unit displaying a result of the measurement of the first usage-rate measuring unit.

3. The wireless disaster-prevention node according to claim 1, further comprising
a first usage-rate determining unit determining that a result of the measurement of the first usage-rate measuring unit is within a predetermined range; and
a first usage-rate display unit displaying the result of the determination of the first usage-rate determining unit.

4. The wireless disaster-prevention node according to claim 1, further comprising a second usage-rate display unit displaying all of or any of the usage rate of the unused frequency channel among a result of the measurement of the second usage-rate measuring unit.

5. The wireless disaster-prevention node according to claim 1, further comprising
a second usage-rate determining unit obtaining the order of unused usage rates from a result of the measurement of the second usage-rate measuring unit; and
a second usage-rate display unit displaying part or all of the order of the usage rates obtained by the second usage-rate determining unit.

6. The wireless disaster-prevention node according to claim 4, wherein the second usage-rate display unit carries out the display when a result of the measurement of the first usage-rate measuring unit is within a predetermined range.

7. The wireless disaster-prevention node according to claim 1, wherein
the first usage-rate measuring unit:
when the wireless signal of the telegram message format is not being received, obtains the radio-field intensity from the wireless communication unit at an every predetermined measurement interval and increments the number of times of measurement;
when the radio-field intensity is within a predetermined range, adds the number determined according to the radio-field intensity to the number of times of usage at that point; and
every time the number of times of measurement reaches a predetermined number of times, divides the number of times of usage by the number of times of measurement to calculate the usage rate.

8. The wireless disaster-prevention node according to claim 1, wherein
the first usage-rate measuring unit:
when the wireless signal having the telegram message format but having the transmission source ID not matching the registered ID is received, adds the number of times of correction calculated by a predetermined method to each of the number of times of usage and the number of times of measurement at that point to accumulate the respective numbers; and,
every time the number of times measurement reaches a predetermined number of times, divides the number of times of usage by the number of times of measurement to calculate the usage rate.

9. The wireless disaster-prevention node according to claim 1, wherein
the second usage-rate measuring unit:
at an every measurement interval, temporarily switches the operating frequency channel of the wireless communication unit to the unused frequency channel, obtains radio-field intensity, and increments the number of times of measurement;
when the radio-field intensity is within a predetermined range, adds the number determined according to the radio-field intensity to the number of times of usage at that point; and
every time the number of times of measurement reaches a predetermined number of times, divides the number of times of usage by the number of times of measurement to calculate the usage rate.

10. The wireless disaster-prevention node according to claim 9, wherein,
when a plurality of the unused frequency channels are present, the second usage-rate measuring unit calculates the usage rates respectively for the individual frequency channels.

11. The wireless disaster-prevention node according to claim 1, wherein
the first usage-rate measuring unit:
when the wireless signal of the telegram message format is not being received, obtains the radio-field intensity from the wireless communication unit at an every predetermined measurement interval, adds 1 to the number of times of measurement, and adds the value obtained by subtracting a predetermined value from the radio-field intensity to a usage quantity at that point to accumulate the quantity; and,
every time the number of times of measurement reaches a predetermined number of times, divides the usage quantity by the number of times of measurement to calculate the usage rate.

12. The wireless disaster-prevention node according to claim 1, wherein
the first usage-rate measuring unit:
when the wireless signal having the telegram message format but having the transmission source ID not matching the registered ID is received, adds the number of times of correction calculated by a predetermined method to the number of times of measurement at that point and adds a usage quantity obtained by multiplying a value, which is obtained by subtracting a predetermined value from the radio-field intensity, by the number of times of correction to a usage quantity at that point to accumulate the quantity; and,
every time the number of times of measurement reaches a predetermined number of times, divides the usage quantity by the number of times of measurement to calculate the usage rate.

13. The wireless disaster-prevention node according to claim 8, wherein
the number of times of correction is calculated by dividing the communication time by the measurement interval and rounding up the number of decimals.

14. The wireless disaster-prevention node according to claim 1, wherein
the second usage-rate measuring unit:
at an every predetermined measurement interval, temporarily switches the operating frequency channel of the wireless communication unit to the unused frequency channel, obtains radio-field intensity, adds 1 to the number of times of measurement, adds a value obtained by subtracting a predetermined value from the radio-field intensity to a usage quantity at that point, and, every time the number of times of measurement reaches a predetermined number of times, divides the usage quantity by the number of times of measurement to calculate the usage rate.

15. The wireless disaster-prevention node according to claim 1, wherein,
while the telegram message of the predetermined format from the sensor node is being received, the second usage-rate measuring unit prohibits the wireless communication unit from switching to the unused frequency channel.

16. The wireless disaster-prevention node according to claim 1, wherein,
any or all of outputs of the first usage-rate measuring unit and the second usage-rate measuring unit is transmitted to and displayed by a receiver.

17. The wireless disaster-prevention node according to claim 1, wherein
the sensor node detects a fire and transmits the wireless signal in accordance with the predetermined telegram message format; and,
when the communication control unit obtains the telegram message demodulated from the wireless signal of the sensor node by the wireless communication unit and determines the fire, the communication control unit relays and transmits a fire signal to a receiver connected by a signal line and causes the receiver to emit an alarm.

18. A wireless disaster-prevention system receiving and processing, by a wireless disaster-prevention node, a wireless signal transmitted from a sensor node and transmitting a result of the processing to a receiver connected by a signal line, wherein
the wireless-disaster prevention node comprising:
a channel setting unit capable of setting an operating frequency channel from among a plurality of frequency channels;
a wireless communication unit receiving a wireless signal in accordance with a predetermined telegram message format output from a sensor node using a frequency channel same as the operating frequency channel set by using the channel setting unit, demodulating the wireless signal, and measuring radio-field intensity;
a communication control unit executing a process based on an telegram message when a transmission source ID obtained from the telegram message demodulated by the wireless communication unit matches a registered ID determined and registered in advance;
a first usage-rate measuring unit measuring a usage rate of the operating frequency channel; and
a second usage-rate measuring unit measuring a usage rate of the unused frequency channel.

19. The wireless disaster-prevention system according to claim 18, wherein
the wireless disaster-prevention node transmits wireless monitoring information including part or all of outputs of the first usage-rate determining unit and the second usage-rate determining unit to the receiver; and
the receiver is provided with a monitoring information processing unit which displays occurrence of a busy state of the wireless disaster-prevention node of a transmission source and the unused frequency channel having the low usage rate to recommend the unused frequency channel as a switching destination based on the wireless monitoring information received from the wireless disaster-prevention node.

20. The wireless disaster-prevention system according to claim 18, wherein
the first usage-rate measuring unit of the wireless disaster-prevention node:
when the wireless signal of the telegram message format is not being received, obtains the radio-field intensity from the wireless communication unit at an every predetermined measurement interval and increments the number of times of measurement;
when the radio-field intensity is within a predetermined range, adds the number determined according to the radio-field intensity to the number of times of usage at that point; and
every time the number of times of measurement reaches a predetermined number of times, divides the number of times of usage by the number of times of measurement to calculate the usage rate.

21. The wireless disaster-prevention system according to claim 18, wherein
the first usage-rate measuring unit of the wireless disaster-prevention node:
when the wireless signal having the telegram message format but having the transmission source ID not matching the registered ID is received, adds the number of times of correction calculated by a predetermined method to each of the number of times of usage and the number of times of measurement at that point to accumulate the respective numbers; and,
every time the number of times measurement reaches a predetermined number of times, divides the number of times of usage by the number of times of measurement to calculate the usage rate.

22. The wireless disaster-prevention system according to claim 18, wherein
the second usage-rate measuring unit of the wireless disaster-prevention node:
at an every predetermined measurement interval, temporarily switches the operating frequency channel of the wireless communication unit to the unused frequency channel, obtains radio-field intensity, and increments the number of times of measurement;
when the radio-field intensity is within a predetermined range, adds the number determined according to the radio-field intensity to the number of times of usage at that point; and
every time the number of times of measurement reaches a predetermined number of times, divides the number of times of usage by the number of times of measurement to calculate the usage rate.

23. The wireless disaster-prevention system according to claim 18, wherein
the first usage-rate measuring unit of the wireless disaster-prevention node:
when the wireless signal of the telegram message format is not being received, obtains the radio-field intensity from the wireless communication unit at an every predetermined measurement interval, adds 1 to the number of times of measurement, and adds the value obtained by subtracting a predetermined value from the radio-field intensity to a usage quantity at that point to accumulate the quantity; and,
every time the number of times of measurement reaches a predetermined number of times, divides the usage quantity by the number of times of measurement to calculate the usage rate.

24. The wireless disaster-prevention system according to claim 18, wherein
the first usage-rate measuring unit:
when the wireless signal having the telegram message format but having the transmission source ID not matching the registered ID is received, adds the number of times of correction calculated by a predetermined method to the number of times of measurement at that point and adds a usage quantity obtained by multiplying a value, which is obtained by subtracting a predetermined value from the radio-field intensity, by the number of times of correction to a usage quantity at that point to accumulate the quantity; and,
every time the number of times of measurement reaches a predetermined number of times, divides the usage quantity by the number of times of measurement to calculate the usage rate.

25. The wireless disaster-prevention system according to claim 18, wherein
the second usage-rate measuring unit:
at an every predetermined measurement interval, temporarily switches the operating frequency channel of the wireless communication unit to the unused frequency channel, obtains radio-field intensity, adds 1 to the number of times of measurement, adds a value obtained by subtracting a predetermined value from the radio-field intensity to a usage quantity at that point, and, every time the number of times of measurement reaches a predetermined number of times, divides the usage quantity by the number of times of measurement to calculate the usage rate.

26. The wireless disaster-prevention system according to claim 18, wherein,
while the telegram message of the predetermined format from the sensor node is being received, the second usage-rate measuring unit of the wireless disaster-prevention node prohibits the wireless communication unit from switching to the unused frequency channel.

27. The wireless disaster-prevention system according to claim 18, wherein
the sensor node detects a fire and transmits the wireless signal in accordance with the predetermined telegram message format; and,
when the communication control unit of the wireless disaster-prevention node obtains the telegram message demodulated from the wireless signal of the sensor node by the wireless communication unit and determines the fire, the communication control unit relays and transmits a fire signal to the receiver and causes the receiver to emit an alarm.
